(19) United States
(12) Patent Application Publication
(10) Pub. No.: US 2014/0000782 A1
(43) Pub. Date: Jan. 2, 2014

(54) ELASTIK-APPLIKATOR

(71) Applicant: Winkler + Dünnebier GmbH, Neuwied (DE)

(72) Inventors: Walter Heinrich, Neuwied (DE); Dennis Sanner, Bauchbach (DE)

(21) Appl. No.: 13/925,157

(22) Filed: Jun. 24, 2013

(30) Foreign Application Priority Data
Jun. 25, 2012 (DE) 10 2012 210 776.2

(51) Int. Cl. B32B 38/18

(52) U.S. Cl. CPC B32B 38/1858
USPC 156/60; 156/538; 156/510

(57) ABSTRACT

An elastic-applicator for applying an elastic element onto a layer of material includes a disc pair and a drive unit for driving the two discs of the disc pair, wherein the discs of the disc pair and the drive units are configured for operation with different speeds is to enable a reliable and uniform application of an elastic element onto a layer web in a most simple manner and at the same time is to be capable to apply elastic elements of different sizes or lengths and stretch coefficients especially easily and in particular without cumbersome retrofitting work. For this, at least one disc of the disc pair has a number of sheath-side circumferential suction openings.

The invention relates to an elastic-applicator for applying an elastic element onto a layer of material including a disc pair and a respective drive unit for driving the two discs of the disc pair, wherein for operation, the discs of the disc pair and the drive units are configured for operating with different absolute speeds, and to a method an elastic applicator for applying an elastic element onto a layer of material.

Hygiene articles such as sanitary pads or disposable diapers normally have elastic elements which can be arranged on the surface of the layer. These serve in particular for forming gathers so that the item can optimally adjust to the body of the wearer. The elastic element should be arranged so as to extend as evenly as possible on the surface of the layer because significantly uneven extents can lead to a poor wearing comfort or to leakage of bodily fluids.

From DE 603 02 531 T2 a device for producing such a hygiene article is known which receives the elastic element by means of circularly arranged pillows, cuts the elastic element and then connects the elastic element at an arrangement station with a layer of the future hygiene article. However, such a kinematically complex construction is prone to errors due to the system and is difficult and with this costly to maintain. Further, the pillow size predetermines the size of the elastic element and cannot be variably changed so as to be adjusted to multiple products. A change of the product size is thus only possible when at least the complete pillow set is exchanged. In addition, the cutting of the elastic elements before and behind the pillows results in the ends of the elastic element not being fixed on the pillow and thus not being able to be held in a stretched state. Therefore they contract again prior to application onto the layer, which leads to an irregular stretching of the elastic element, in particular at their ends, in the finished product.

A further device for producing hygiene articles with elastic elements is known from the printed publication WO 2004/073568 A1. There, the elastic material is guided over a roller or disc construction and later glued to the layer. The elastic element is stretched during the gluing as a result of the speed differential between the layer web and the supplied elastic element. When the elastic element is stretched during application onto the layer web the, restoring forces thus have to be held by the front ends of the elastic element. Because these forces already occur during the first gluing of the elastic element, it is possible that the bonding of the elastic element to the layer web that has taken place up to this point is insufficient to compensate the restoring forces. It is therefore possible that the already stretched elastic element detaches from the layer web or is displaced tangentially so that the stretching is decreased or is lost entirely.

From the printed publication DE 32 38 051 A1 a method and a device for application of elastic elements onto a material web is also known in which elastic elements are stretched during the transfer from one disc to another disc. The respective elastic elements are held in this device at the beginning and end. However, a disadvantage of this configuration is that the discs have specially made format templates for transport and transfer of the elastic elements, which is why a change of format (for example in the case of product change) requires an exchange and a new production of format templates. This causes long down times and additional costs during the format change.

The invention is therefore based on the object to set forth an elastic-applicator and a method for operating an elastic-applicator of the above mentioned type which enables a reliable and uniform application of an elastic element onto a layer web in a most simple manner and at the same time enables application of elastic elements of different sizes or lengths and stretch coefficients in a particularly easy manner and in particular without cumbersome reconstructions.

With regard to the elastic applicator, this object is solved according to the invention in that at least one disc of the disc pair has a number of suction openings circumferentially surrounding the sheath.

With regard to the method, the mentioned object is solved in that the elastic element is cursed guided through a disc pair before it is connected with the material web wherein the elastic element is stretched by the disc pair in that the first disc of the disc pair which is situated in the guide path of the elastic element rotates at a slower speed then the second disc of the disc pair which is situated in the guide path of the elastic element and in that rotational speed or the circumferential speed of the second disc and the speed of the supplied layer of material are essentially the same and the elastic material is held on the discs by a number of suction openings surrounding the sheath circumferentially.

The invention is based on the idea that a complete and uniform application of the stretched elastic element onto the layer of material, for example a layer of a nonwoven, can be achieved when the elastic element is not additionally stretched or has to be stretched when being applied or glued onto the layer of material. This can be achieved in that an intended relative speed of the elastic element at the supplied layer of material is omitted during the gluing. An application of the stretched elastic element onto a layer of material at same speed is enabled when the element has already been stretched to the desired length or with the desired stretch factor prior to application or gluing to the layer of material. Such a stretching of the elastic element prior to the actual application onto the material web is therefore to be achieved by means of two discs arranged upstream which together form a disc pair. For this, the rotational speed of the two discs can be set so that the elastic element attains the desired stretch factor or stretching when being transferred from one disc to the next.

The invention is further based on the idea that a most flexible setting of different stretching parameters but also lengths of the elastic material, and with this also different product sizes of the finished products, can be achieved when the exchange of transport and or fastening units for the elastic element which are specially configured for a format length and format stretching is not required. For this, at least one disc of the disc pair, however preferably both discs of the disc pair, are provided with sheath-side circumferential suction openings.

In order to easily adjust the relative speed of the two discs that stretch the elastic element to the desired stretch factor, in a preferred embodiment the drive units are configured as direct drives i.e., as continuously adjustable and directly adjustable drive units. Thus, different products with different stretch factors can be successively produced without delays and the stretch factor along an individual elastic element can also be adjusted. For conventional stretch factors in the range of 60% to 100% speed ratios of for example 1.6 to 2 are optimal. Because the discs are advantageously provided with as many sheath-side circumferential suction openings as possible, the elastic element can be stretched section by section in each region between two openings during the transfer. Usually, an un-stretched elastic strip depending on its length covers 10 to 25 suction openings on each disc, whereas a stretched strip covers more on a disc of the same geometry, corresponding to the degree of stretching. A large number of suction openings on the discs leads to a small distance on the sheath surface between the suction openings. As a result, only a very small portion at the beginning and end of the strip remains un-stretched independent of the length of the elastic elements and independent of the stretch factor, namely the portion which comes to lie before the first covered suction opening and behind the last covered suction opening on the last disc of the disc pair. This border region is usually 1-2 mm and can thus be kept particularly small at a corresponding number of suction openings.

For avoiding a tangential displacement of the elastic element during transfer between the discs, in a preferred embodiment the surface of the rollers is provided with a rough coating. The roughness of the surface is designed to compensate the tangential force acting on the elastic elements so that a sliding of the elastic elements can be avoided.

The grip of the elastic element and also the transfer from one disc to the next is achieved in a preferred embodiment via a suction force which is generated by a negative pressure unit and acts on the elastic element through the suction openings.

For the secure transport of the elastic elements along the discs or rollers, the negative pressure units in a particularly advantageous embodiment are configured fixed in position and extend over the entire region of the discs along which the elastic element is transported. As a result of the positionally fixed arrangement of the negative pressure unit, the sheath surface with the circumferential suction openings continuously rotates over the negative pressure unit so that at each time point a sufficient number of suction openings with corresponding negative pressure for receiving the elastic elements are available independent of the length of the elastic material. In an advantageous embodiment, the negative pressure unit has a number of chambers in which the negative pressure, for example generated by a vacuum pump, can be varied. The negative pressure can be controlled so that when the elastic element is transferred, an optimal pressure is applied for the uniform transfer.

The elastic element can be stretched to the desired stretch factor particularly reliably when the elastic elements are cut to size prior to the stretching. For this, in an advantageous embodiment, the elastic element is cut to the desired length by means of a cutting device prior to the transfer onto the disc pair. Thus, the cutting process does not influence the stretch factor.

In an advantageous embodiment, the cutting device is arranged for this purpose before the rollers and cuts the elastic elements against a strip with a smooth surface. In order to avoid back snapping of the elastic element during the cutting process in a particularly advantageous embodiment it is not cut against a fixed strip but against the first transfer disc with smooth surface. This has the effect that a negative pressure unit, which is situated in the transfer disc, suctions the cut elastic element and the layer of material of the elastic element against the roller thereby holding the elastic element and the layer of material in position before, during and after the cutting process.

In an advantageous embodiment, the stretched elastic element is subsequently connected with a layer of material for example made of a nonwoven. The layer of material can be correspondingly prepared for the application prior to contact with the elastic element by a gluing unit for example by applying of adhesive layer onto the layer of material. As an alternative, the connection of the elastic element and the layer of material by embossment of both is also possible.

The advantages achieved with the invention are in particular that when connecting the elastic material and the layer webs at the same speed and thus without relative speed, additional pulling forces on the materials can be avoided. This enables a particularly uniform stretching and application of the elastic element. In addition the stretching of the elastic element before hand by means of two discs or rollers with different speeds achieves in a most simple way that the desired stretching can be adjusted to the demands correspondingly variably and within a short time by varying the rotational speeds. Also the cutting device arranged upstream allows cutting of the elastic elements to size in an adjustable and individual manner. As a result of the suction openings, elastic elements of any length can be stretched when being transferred from one disc to the next disc and also elastic elements of any length can be held by these discs. An exchange of fastening units which is time- work- and cost-intensive and which would also lead to a short term standstill of the production processes can thus be avoided.

An exemplary embodiment is explained in more detail by way of the drawing. It is shown in:

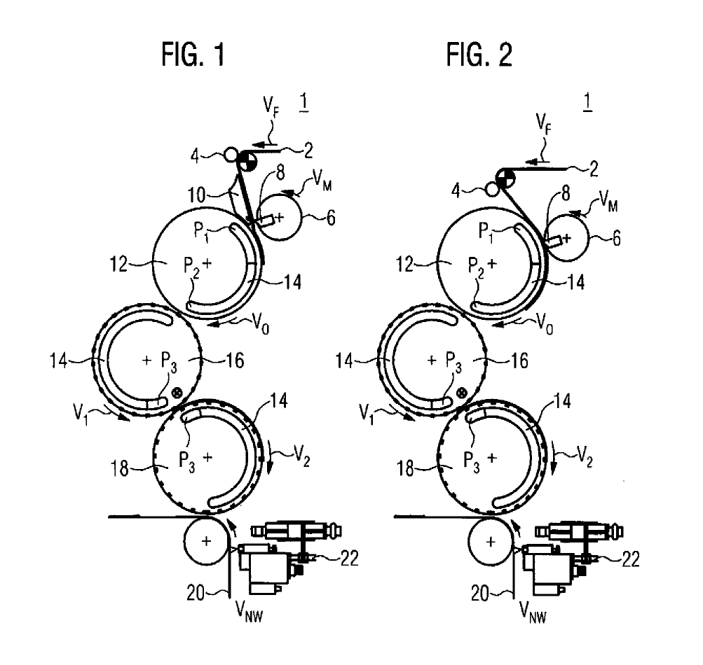

FIG. 1 an elastic applicator with a cutting device against a strip,

FIG. 2 an elastic applicator with a cutting device against a smooth disc,

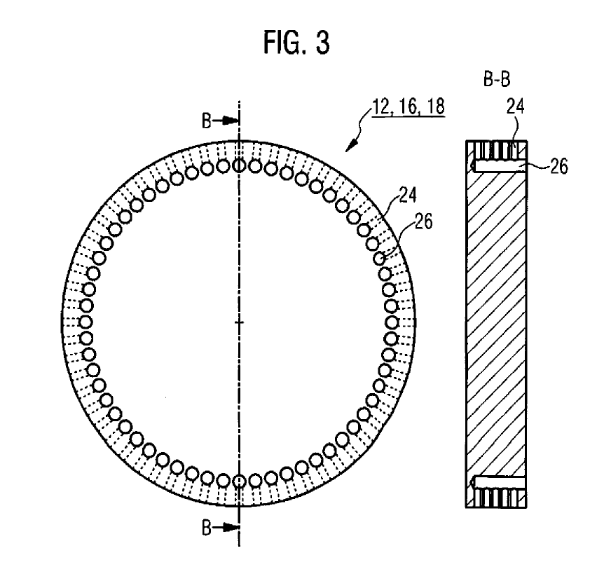

FIG. 3 a disc with suction opening, which circumferentially surround the sheath,

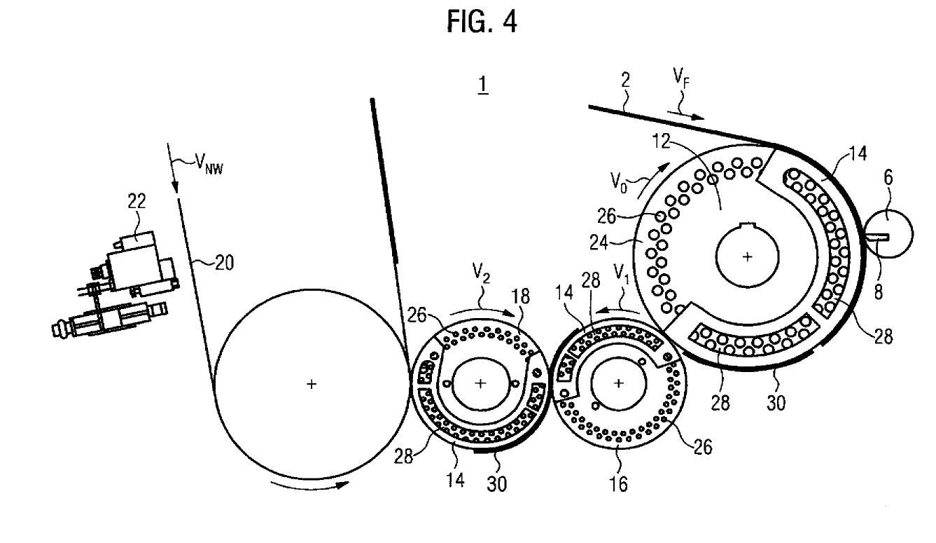

FIG. 4 negative pressure system of an elastic applicator,

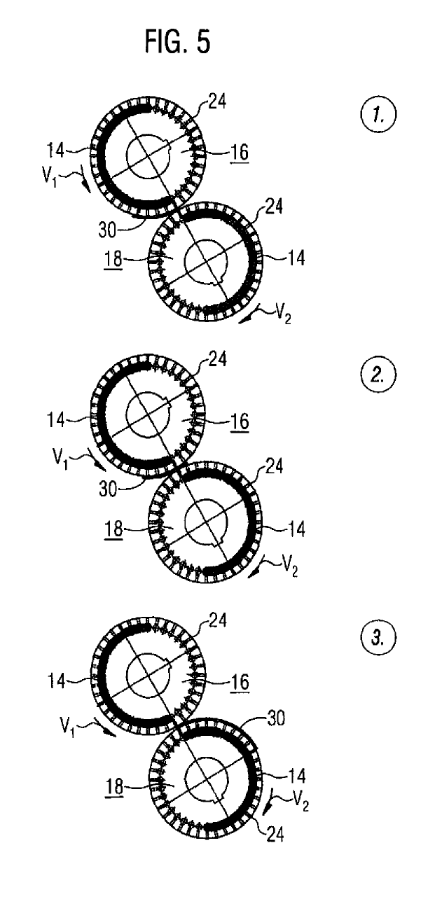

FIG. 5 method for stretching the elastic element.

In all figures same parts are provided with the same reference signs.

According to FIG. 1, a material web 2 of an elastic element is supplied to the elastic applicator 1 from an external and not shown supply unit. This elastic element may for example consist of plastic foam or another material with the desired elastic properties. The material web 2 is guided over deflector rollers 4 to a cutting device 6 of the elastic-applicator 1. The cutting device 6 includes a rotatable disc on which a cutting edge or a cutting knife 8 is fastened. As cutting surface a fixed counter strip 10 with a smooth surface is provided in the cutting device 6 in the present exemplary embodiment. The material web 2 is guided along this counter strip 10 and is cut by the cutting knife 8 to the desired size of the elastic elements. By varying the rotational speed v_{M} of the disc on which the cutting knife 8 is fastened in relation to the speed v_{F} of the material web of the elastic element, the desired size of the elastic elements can be adjusted individually for each product.

The cut-to-size elastic element is then transferred to a transfer disc or transfer roller 12 on which the elastic element is held on the transfer disc 12 by means of negative pressure generated by a number of negative pressure units 14. The negative pressure units 14 are fixed in position adjacent to or in the disc and do not rotate along with the disc. For transferring the negative pressure onto the elastic element, a plurality of suction opening rows 24 are provided on the surface of the transfer disc 12, which suction opening rows 24 are configured in the form of suction bores. The transfer disc 12 rotates with an adjustable speed v₀ which can be greater or identical to the speed of the elastic element V_{F}.

The transfer disc 12 then transfers the elastic element to a disc pair or roller pair 16, 18. This disc pair 16, 18 like the transfer disc 12 also has its own negative pressure units 14, which are arranged fixed in position adjacent to or in the individual discs. These negative pressure units 14 generate an adjustable pressure profile, which on one hand holds the elastic element particularly reliably on the discs and on the other hand enables a sliding-resistant transfer of the elastic element from disc 16 to disc 18.

The first disc of the disc pair 16 rotates with an adjustable speed This speed can correspond to the speed v₀ of the transfer disc 12 to enable a most uniform transfer of the elastic material. However, it is also possible to rotate the first disc of the disc pair 16 with a higher speed so that the gap, i.e., the distance between two cut elastic elements is increased. This can be individually adjusted in accordance with the demands. When the elastic element is transferred from the transfer disc 12 to the disc 16, the elastic element is advantageously not stretched or only stretched to a very minor degree even when the speed v₁>v₀. This is achieved on one hand by a very low negative pressure at the end of the suction path of the transfer disc 12 and also by a smooth surface of the transfer disc 12. Thus, the cut strips can be pulled off the disc without causing significant stretching of the strips i.e., the speed differential between the discs 12 and 16 results in generating a distance between the strips.

The second disc of the disc pair 18 rotates with an adjustable speed v₂. This speed is greater than the speed of the first disc of the disc pair v₁. As a result of the speed differential between the first disc at the second disc of the disc pair 16, 18 the elastic element is stretched during the transfer. The stretching coefficient or stretch factor thereby directly depends on the speed differential. Usually, stretch coefficients of about 60% 100% can for example be achieved at same disc diameters at speed differentials in the range of v₂=1.6-2 v₁.

In this regard it is advantageous when the discs also rotate clocked, which means that the discs rotate per machine tact i.e., per produced product always by a whole number of suction openings 24, which number is to be adjusted depending on the product. This allows decreasing fluctuations in the position and the length of the stretched strips.

The surface of the two discs of the disc pair 16, 18 can be configured rough in order to additionally suppress a tangential displacement and decrease of the stretch factor of the stretched elastic element. The roughness of the surface thus serves to increase the friction coefficient between the elastic element and the disc and can be adjusted to the material. In the case of plastic-foam like materials for the elastic element, a relatively rough grain is conceivable, in other materials this grain may be reduced or the rough surface maybe entirely omitted.

The pressure profiles of the negative pressure chambers 14 in the exemplary embodiment according to FIG. 1 are selected so that the greatest negative pressure and with this the greatest suction force exists during the stretching process between the two discs of the disc pair 16, 18. In the preceding transfers onto the transfer disc 12 and onto the first disc of the disc pair 16 a lesser negative pressure is set to facilitate a transfer or stripping off of the elastic element by the discs. In the exemplary embodiment according to FIG. 1, three pressure regions are given as examples. However, these can be adjusted in correspondence with the above demands to the operating parameters, such as for example speeds of the discs or the material of the elastic element. A different pressure profile than that of the exemplary embodiment according to FIG. 1 is also conceivable.

The second disc of the disc pair 18 subsequently carries the stretched elastic element onto a supplied material web 20, for example a nonwoven. For this, the material web 20 can be prepared before hand by means of an adhesive unit 22 for application with the elastic element. For a particularly secure and uniform application of the stretched elastic element onto the material web 20, the speeds of the second disc of the disc pair v₂ and the material web v_{NW} are essentially the same. Thus no further additional stretching of the elastic element occurs during application onto the material web. Thus, additional pulling forces which may occur during the stretching of the elastic element during the gluing can be avoided. As an alternative to the shown gluing of the stretched elastic element with the material web, an embossment of both is also possible.

The suction openings 24 through which the negative pressure is transferred to the elastic element and is held on the discs 12, 16, 18 is distributed over the entire sheath surface. This makes it possible to transport and hold elastic elements of any length.

The exemplary embodiment according to FIG. 2 differs from the one of FIG. 1 essentially by the arrangement and mode of function of the cutting device 6. In the exemplary embodiment according to FIG. 2, the material web of the elastic element is directly transferred to the transfer disc 12 and the cutting device cuts the material web on the smooth transfer disc 12. The elastic element is thus already securely held on the disc during the cutting process by the negative pressure unit 14. A back snapping of the elastic element during the cutting process is thus suppressed.

The disc 12, 16, 18 with the number of sheath-side circumferential suction openings 24 is shown in FIG. 3. On the shown front side of the disc 12, 16, 18 a number of openings to the suction channels 26 are shown, which each interact with a row of suction openings 24, which are configured as suction bores. As soon as the suction channels 26 pass the negative pressure units 14 when the disc 12, 16, 18 rotates, the corresponding negative pressure is applied to the suction openings on the sheath surface of the disc 12, 16, 18 so that the elastic material can be securely held on the disc 12, 16, 18. In the present exemplary embodiment only one ring of suction channels 26 is shown, however, it is also possible that the suction channels 26 are arranged in multiple rings offset to each other as shown for example for two rings in the disc arrangement of the exemplary embodiment according to FIG. 4.

An exemplary negative pressure system is shown in the exemplary embodiment according to FIG. 4. Each negative pressure unit 14 includes multiple negative pressure chambers 28 which can be controlled separate from each other and can individually be impinged with negative pressure. These negative pressure chambers 28 are arranged on the discs 12, 16, 18 such that the discs 12, 16, 18 are guided past the negative pressure chambers 28 with the suction channels 26. The number, configuration and positioning of the shown negative pressure chambers 28 is only exemplary, in particular further negative pressure chambers 28 can be provided in order to be able to provide an optimized negative pressure profile. For this, each negative pressure chamber 28 has their own supply line.

The possibility to individually control the negative pressure chambers 28, enables an optimal transport and an optimal stretching of the elastic elements 30 in the first place. It is conceivable for example to apply only a weak negative pressure to the negative pressure chamber 28 of the transfer disc 12 which is last in transport direction of the elastic element 30, in particular a negative pressure which is weak relative to the negative pressure chamber 28 of the disc 16, which receives the elastic element from the transfer disc 12. In combination with a smooth surface of the transfer disc 12 this achieves that the cut strips of the elastic element 30 are pulled from the transfer disc without the strips being significantly stretched i.e., the speed differential of the discs 12 and 16 results in a distance between the strips. It is thus possible to control the distances of the individual elastic elements 30.

The method for stretching the elastic element is exemplary shown in FIG. 5 by way of three outlined method steps. In the first method step, the elastic element 30 is held by the negative pressure on the suction openings 24 of the first disc of the disc pair 16. The elastic element 30 is positioned on the disc 16 so that the front edge is positioned at a row of suction openings 24. In the second method step this front edge of the elastic element is received by a row of suction openings 24 of the second disc of the disc pair 18. The row of suction openings 24 of the first disc 16 has left its associated negative pressure chamber, which causes the front edge of the elastic element 32 to be no longer able to be held by the first disc 16. The elastic element 30 is subsequently transferred, one suction opening at a time, to the second disc 18. Because this second disc 18 however rotates with a higher circumferential speed v₂>v₁ than the first disc 16, the elastic element 30 is additionally stretched at the transfer and lies on the second disc 18 in the stretched state as it is shown in the third method step.

With all exemplary embodiments it is thus possible to achieve a desired stretch factor of the elastic material in a continuous manner via the adjustment of the speeds of the disc pair v₁ and v₂. This is also possible during the operation of the elastic-applicator at any time. With this, additional downtimes and cumbersome reconstruction of the system during product change or format change are avoided. Further, the directly upstream-located cutting device allows omitting format parts in the cutting-to-size and with this any length can be continuously set. As a result of the exclusively simple rotating movements of the individual components of the system and the avoidance of complex production processes the error proneness of the system and maintenance and cleaning times can be kept low.

### LIST OF REFERENCE SIGNS

1 elastic-applicator
2 material webs of the elastic element
4 deflector rollers
6 cutting device
8 cutting knife
10 counter rail
12 transfer disc
14 negative pressure unit
16 first disc of the disc pair
18 second disc of the disc pair
20 material web
22 gluing unit
24 suction openings
26 suction channels
28 negative pressure chamber
30 elastic material
V_{F} speed of the material web of the elastic element
V_{M} speed of the cutting disc
V₀ speed of the transfer disc
V₁ speed of the first disc of the disc pair
V₂ speed of the second disc of the disc pair
V_{NW} speed of the material web

What is claimed is:

1.-10. (canceled)

11. An elastic-applicator for applying an elastic element onto a layer of material, comprising:
a disc pair comprising two discs; and
drive units for driving the two discs of the disc pair, wherein the discs of the disc pair and the drive units are configured for operation at different speeds, wherein at least one disc of the disc pair has a number of suction openings which circumferentially surround a sheath of the disc.

12. The elastic-applicator of claim 11, wherein the drive units are configured so that the speeds can be adjusted or changed continuously and directly.

13. The elastic-applicator of claim 11, wherein the two discs of the disc pair are provided with a rough surface coating.

14. The elastic-applicator of claim 11, wherein the two discs of the disc pair each are provided with a negative pressure unit.

15. The elastic-applicator of claim 14, wherein the negative pressure unit is arranged fixed in position and extends essentially along an entire transport path of the elastic element.

16. The elastic-applicator of claim 14, wherein the negative pressure unit includes chambers.

17. The elastic-applicator of claim 1, further comprising a cutting device.

18. The elastic-applicator of claim 17, wherein the cutting device includes a cutting knife and a planar counter strip, said counter strip forming a cutting surface.

19. The elastic-applicator of claim 17, further comprising a further disc is as cutting surface said further disc forming a cutting surface.

20. A method for operating an elastic-applicator for applying an elastic element onto a layer of material according to one of the claims 1 to 9, comprising:
rotating a first disc of a disc pair with a lower speed than a second disc of the disc pair;
supplying the layer of material at a speed essentially corresponding to the speed of the first disc;
guiding the elastic element through the disc pair, thereby stretching the elastic element, wherein the elastic material is held on the discs by a number of sheath-side circumferential suction openings; and
connecting the elastic element with the layer of material.
